(19) United States
(12) Patent Application Publication
(10) Pub. No.: US 2007/0213480 A1
(43) Pub. Date: Sep. 13, 2007

(54) Concrete reinforcing material for improving durability of concrete structure and process for preparing the same

(75) Inventors: Myung Sug Cho, Daejeon (KR); Young Chul Song, Daejeon (KR); Jong Ken Kim, Seoul (KR); Jae Ho Lim, Seoul (KR)

Correspondence Address: BEYER WEAVER LLP, P.O. BOX 70250, OAKLAND, CA, 94612-0250, US

(73) Assignee: Korea Electronic Power Corporation

(21) Appl. No.: 11/519,703

(22) Filed: Sep. 11, 2006

(30) Foreign Application Priority Data
Oct. 31, 2005 (KR) 10-2005-0103500

(51) Int. Cl. C08F 2/00; C08F 4/00; C08F 4/16; C08F 120/18

(52) U.S. Cl. 526/88; 526/194; 526/329.7

(57) ABSTRACT

Disclosed herein is a concrete reinforcing material for improving the durability of a concrete structure. The concrete reinforcing material quickly penetrates deep into a concrete structure by simply applying the material onto the surface of a concrete structure in use and fills fine pores of the concrete structure through a sol-gel process by hydrolysis to reinforce the concrete structure and form a blocking layer, so that the concrete structure is protected from harmful substances, and at the same time, cracks are repaired, thus achieving integration of the concrete structure. Further disclosed is a process for preparing the concrete reinforcing material.

### BACKGROUND OF THE INVENTION

1. Field of the Invention

The present invention relates to a concrete reinforcing material for improving the durability of a concrete structure and a process for preparing the concrete reinforcing material. More specifically, the present invention relates to a concrete reinforcing material composition that quickly penetrates deep into a concrete structure by simply applying the composition onto the surface of a concrete structure in use and fills fine pores of the concrete structure through a sol-gel process by hydrolysis to reinforce the concrete structure and form a blocking layer, so that the concrete structure is protected from harmful substances, and at the same time, cracks are repaired, thus achieving integration of the concrete structure; and a process for preparing the concrete reinforcing material composition.

2. Description of the Related Art

Various environmental factors, particularly, chlorine components and water, adversely affect the durability of currently used inorganic concrete products and porous concrete structures using the inorganic concrete products, resulting in a rapid shortening in the service life of the concrete structures.

These environmental factors include acid rain owing to automobile exhaust gases and contaminants, e.g., dust. Further, organic synthetic polymer-based coating materials and finishing materials impede the ventilation of concrete, resulting in aging of concrete structures, and leave defects, such as yellowing, choking, swelling, splitting and delamination, on concrete structures due to UV irradiation, causing earlier corrosion of steel-reinforced concrete structures.

Most concrete structures are subjected to aging by slow action of combinations of several or many aging factors, and after casting of concrete, this aging becomes serious with the passage of time.

Thus, penetration of water and external harmful substances into concrete must be thoroughly blocked in order to prevent aging of the concrete. In connection with the durability of concrete structures in the construction fields, methods of removing aged sites of concrete structures and repairing the sites by using a variety of mortars have been employed for the maintenance and management of the concrete structures.

Some methods have been employed up to now in order to inhibit aging and improve the waterproof performance of steel-reinforced concrete structures. For example, organic or inorganic materials are coated onto the surface of steel-reinforced concrete structures, or are penetrated into steel-reinforced concrete structures. Conventional organic polymeric materials, such as silicone, epoxy and urethane resins, have been used as coating agents to form coating layers on the surface of concrete. These coating agents are effective in achieving waterproof effects due to the formation of coating layers. However, vibration, water vapor pressure and difference in the elastic modulus between the coating agents and concrete cause various problems, such as destruction or peeling of coating layers. Further, inorganic materials possess fundamental limitations in their use because they are not integrated with concrete. Conventional organic and inorganic materials have still been used as waterproofing agents because there is a lack of practical alternatives.

In addition to organic and inorganic materials, liquid typed penetrators are currently used to improve the durability of concrete and porous structures using concrete. Recently developed liquid surface penetrators are inorganic substances that are applied onto the surface of inorganic materials, such as concrete, to minimize the influence made by salt or water, and particularly, to make surface layers hydrophobic, which enables control of water content. Under such circumstances, numerous studies have focused on materials capable of providing hydrophobicity. Representative examples of such materials include silanes, alkylalkoxysilanes, silanols, siloxanes, oligomeric siloxanes and polysiloxanes, some of which are described in Korean Patent Application Nos. 2002-3714 and 2002-90434 and German Patent No. 2356142. However, the conventional surface penetrators serve to simply form coating layers on the surface of construction materials, and show insufficient initial water repellency without chemically binding to the construction materials or poor long-term consistency in water repellency.

### SUMMARY OF THE INVENTION

The inventors have made efforts in order to solve the problems of conventional concrete reinforcing materials, such as surface penetrators and coating agents, for improving the durability and the waterproofness of concrete structures. Therefore, it is one object of the present invention to provide a concrete reinforcing material that penetrates deep into a concrete structure, compactly fills internal pores of the concrete structure, thus achieving an enhancement in the strength and durability performance of the concrete structure due to concrete reinforcing effects, and integrally binds to the concrete structure to form a stable and efficient waterproof layer.

It is another object of the present invention to provide a process for preparing the concrete reinforcing material.

In accordance with one aspect of the present invention for achieving the above objects, there is provided a process for preparing a concrete reinforcing material, the process comprising the steps of adding 50 to 95% by weight of an alkoxysilicate and 5 to 50% by weight of a mixture of hydroxyalkylacrylate monomer and alkylacrylate monomer to a reactor, adding a catalyst to the reactor, stirring the mixture at a speed of 30-100 rpm while introducing nitrogen gas into the reactor, and reacting the mixture for 5-10 hours while maintaining the internal temperature of the reactor at 60-100° C.

### BRIEF DESCRIPTION OF THE DRAWINGS

The above and other objects, features and other advantages of the present invention will be more clearly understood from the following detailed description taken in conjunction with the accompanying drawings, in which:

FIG. 1 schematically shows a reaction mechanism of a concrete reinforcing material according to one embodiment of the present invention; and

FIG. 2 shows an apparatus for testing the water permeability of a concrete reinforcing material according to the present invention.

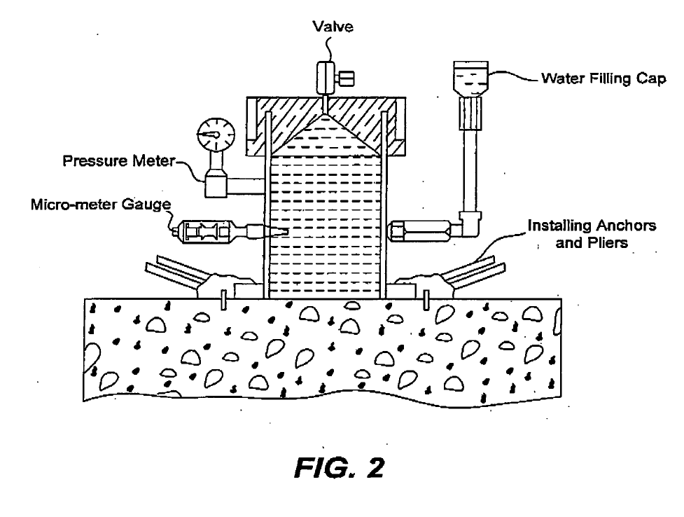

### DESCRIPTION OF THE PREFERRED EMBODIMENTS

The process of the present invention may further comprise the steps of stopping the introduction of nitrogen gas when ethanol is not discharged through a reflux condenser from the reactor any further or is discharged in an amount of less than 20% and preferably less than 5% of the amount discharged at the initial stage of the reaction, and lowering the temperature of the reaction product to 40° C. or less.

The said alkoxysilicate is preferably added in an amount of 70 to 90% by weight, and the substituted or unsubstituted alkyacrylate monomer is preferably added in an amount of 10 to 30% by weight.

The stirring is carried out at a speed of 40 to 80 rpm, and the reaction is preferably performed at 80-90° C. for 7-9 hours.

The alkoxysilicate preferably has one to ten carbon atoms, and the substituted or unsubstituted alkyacrylate monomer preferably has one to ten carbon atoms.

Examples of suitable alkoxysilicates include tetraethylorthosilicate, tetramethylorthosilicate, trimethylmethoxyorthosilicate, trimethylethoxyorthosilicate, dimethyldimethoxyorthosilicate, dimethyldiethoxyorthosilicate, methyltrimethoxyorthosilicate, methyltriethoxyorthosilicate, tetramethoxyorthosilicate, tetraethoxyorthosilicate, methyldimethoxyorthosilicate, methyldiethoxyorthosilicate, dimethylethoxyorthosilicate, dimethylvinylmethoxyorthosilicate, dimethylvinylethoxyorthosilicate, methylvinyldimethoxyorthosilicate, dimethylvinylmethoxyorthosilicate, dimethylvinylethoxyorthosilicate, methylvinyldimethoxyorthosilicate, methylvinyldiethoxyorthosilicate, diphenyldimethoxyorthosilicate, diphenyldiethoxyorthosilicate, phenyltrimethoxyorthosilicate, phenyltriethoxyorthosilicate, octadecyltrimethoxyorthosilicate, and octadecyltriethoxyorthosilicate. These alkoxysilicates may be used alone or as a mixtures thereof.

Examples of suitable substituted or unsubstituted alkyacrylate monomer include butyl acrylate and methyl methacrylate. As a hydroxyalkylacrylate monomer, hydroxyethyl acrylate can be used.

As the catalyst, there can be used a reaction initiator, for example, 2,2′-azo-bis-isobutyronitrile (AIBN, C₈H₁₂N₄) or amidobenzonitrile (AMBN, C₁₀H₁₆N₄).

The monomer mixture may consist of 4 to 10% by weight of at least one hydroxyalkylacrylate monomer having a hydroxyl group and 90 to 96% by weight of at least one alkylacrylate monomer having no hydroxyl group.

The present invention also provides a concrete reinforcing material prepared by the present process.

The process for preparing a concrete reinforcing material and the concrete reinforcing material prepared by the process according to the present invention will now be described in more detail.

The concrete reinforcing material of the present invention is prepared by using a sol-gel reaction of a silicate compound. According to the chemical mechanism of the sol-gel reaction, various kinds of inorganic networks are formed from silcone resin or a metal alkoxide monomer precursor. The sol-gel process arising in the silicate compound is a process wherein the silicate compound penetrates concrete to form a colloidal state (sol) and then the sol is gelled to form a liquid network (gel) so that the gel binds to cement hydrates to form an inorganic network.

Based on this sol-gel process, a potent inorganic network can be formed by alkaline concrete. The application of the sol-gel process to concrete leads to an enhancement in the strength and durability of the concrete. At this time, a silicate precursor necessary to form a sol state, i.e. a colloidal state, is composed of a material in which a metal or metalloid is surrounded by various reactive ligands. A metal alkoxide is most commonly used as a silicate precursor because it readily reacts with water. The most widely used metal alkoxides are alkoxysilanes, for examples, tetramethoxyorthosilicate (TMOS) and tetraethoxyorthosilicate (TEOS).

As depicted in Reaction Scheme 1, the sol-gel process is generally divided into the following three reactions: hydrolysis, alcohol condensation and water condensation, through which a network is formed.

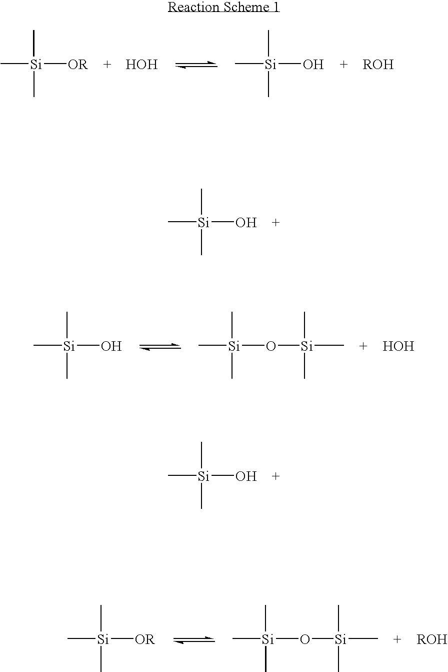

The characteristics and properties of the special sol-gel inorganic network are associated with various factors, which affect the hydrolysis and condensation reaction rates. Factors affecting these reactions are pH, temperature, reaction time, concentration of reagents used, characteristics and concentration of catalysts used, molar ratio (R) of H₂O and metal elements, aging temperature and time, drying, and the like.

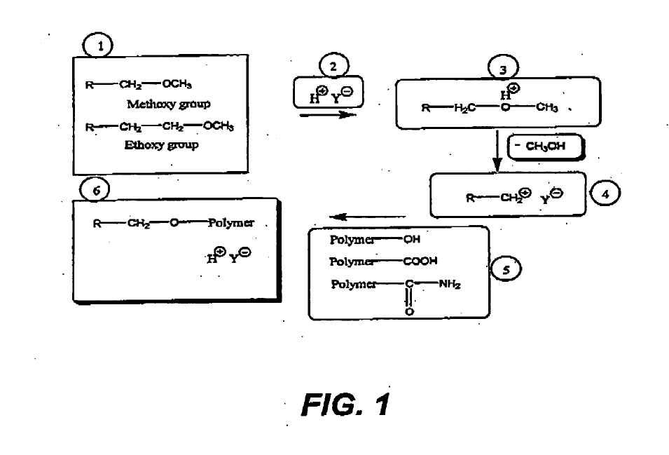

The concrete reinforcing material of the present invention, which is composed of a silicate moiety having an alkoxy group and a polymeric moiety, is dealcoholized through a catalyzation reaction due to the present of bases, such as sodium oxide, potassium oxide and calcium hydroxide coexisting, in concrete (see, FIG. 1). The compounds having an alkoxy group are converted to (+) and (−) ionic forms due to their electronic instability. The ionic forms thus converted readily bind to other compounds and react with cement hydrates to form a network.

Therefore, the concrete reinforcing material of the present invention is an organic/inorganic complex composed of an inorganic silicate moiety having an alkoxy group and an organic polymeric moiety having an alkoxy group. Silicate compounds having an alkoxy group react with calcium hydroxide present in concrete to lose the alcohol moiety and become a gel-state. Likewise, polymeric materials having an alkoxy group are crosslinked to be gelled. Consequently, the concrete reinforcing material according to the present invention reacts with calcium hydroxide, acting as a catalyst, present in concrete to be naturally formed into an organic/inorganic complex.

Since it is preferable that the concrete reinforcing material penetrates deep into concrete and is gelled, the concrete reinforcing material is required to have an appropriate viscosity. The alkoxy group readily reacts with a compound having a hydroxyl group in the presence of a catalyst to lose the corresponding alcohol and bind to the compound. When a compound, e.g., alkoxysilicates, having four functional groups reacts with a compound having several hydroxyl groups, gelling occurs. Proper control of the functional groups enables prevention of gelling and preparation of a polymer having an appropriate viscosity.

In the present invention, 50 to 95% by weight of an alkoxysilicate and 5 to 50% by weight of a mixture of hydroxyalkylacrylate monomer and alkylacrylate monomer are used to achieve an appropriate viscosity. The acrylate monomer mixture preferably consists of 4 to 10% by weight of hydroxyalkylacrylate monomer and 90 to 96% by weight of alkylacrylate monomer.

When a hydroxyalkylacrylate monomer having a hydroxyl (OH) group and at least one alkylacrylate monomer are mixed with an alkoxysilicate and the mixture is copolymerized by using a reaction initiator, such as AIBN, the monomers having a double bond form a polymer.

The alkoxysilicate reacts with the hydroxyalkylacrylate monomer to form an organic/inorganic complex.

When the concrete reinforcing material in the form of an organic/inorganic complex according to the present invention is applied onto the surface of concrete by using an instrument, such as a spray gun or a brush, it improves the durability of newly constructed concrete structures. In addition, the concrete reinforcing material of the present invention improves the performance of previously constructed concrete structures without removal of concrete whose performance is deteriorated. That, is, when the concrete reinforcing material in a sol state according to the present invention is applied onto the surface of concrete, it can penetrate deep into the concrete where it is in contact with water present within the concrete, hydrolyzed to form silica (SiO₂) having a particle size of several nanometers, gelled by a sol-gel process and reacts with concrete hydrates, so that internal pores of the concrete are compactly filled with the reaction products. As a result, the concrete reinforcing material of the present invention improves the strength and durability performance of the concrete due to concrete reinforcing effects, and the monomer having a hydroxyl group imparts waterproof performance and impact absorption performance to the concrete, thus achieving an improvement in long-term durability performance. The concrete reinforcing material of the present invention is applied onto the surface of a concrete structure to form a physically/chemically stable reinforcing layer on the surface and inside of the concrete structure.

Hereinafter, the present invention will be explained in more detail with reference to the following examples. However, the following examples are provided to assist the understanding of the present invention, and the present invention is not to be construed as being limited to these examples.

### EXAMPLES

### Examples 1 to 4

Butyl acrylate, methyl methacrylate and hydroxyethyl acrylate were mixed in a weight ratio of 70:24:6 to obtain a mixture. 50, 35, 20 and 5% by weight of the mixture were introduced into polymerization reactors, and then 50, 65, 80 and 95% by weight of tetraethylorthosilicate were added thereto, respectively. AIBN as a reaction initiator was added to the reactor. The mixtures were allowed to react for 8 hours while maintaining the temperature at 80° C. to prepare concrete reinforcing material compositions.

### Test Example 1

### Measurement of Viscosity

The viscosity of each of the concrete reinforcing materials prepared in Examples 1 to 4 was measured using a single-cylinder rotational viscometer in accordance with the procedure of KS F 3705. Specifically, the viscosity of the concrete reinforcing material was determined by using a Brookfield viscometer (DV-II⁺), which measured a torque necessary to constantly rotate a spindle immersed up to a marked line in the concrete reinforcing material. The results are shown in Table 1.

TABLE 1

Weight ratio of silicate to
acrylate monomer mixture

| Sample | 50:50 | 65:35 | 80:20 | 95:5 |
|---|---|---|---|---|
| Viscosity (cps) | 529 | 121 | 67 | 23 |

As can be seen from the data shown in Table 1, the viscosity of the concrete reinforcing materials was decreased with increasing weight of the silicate. The reason for this tendency is believed to be because the tetraethylorthosilicate has a low viscosity not higher than 10 cps and the proportion of the monomers determining the viscosity of the concrete reinforcing materials was lowered.

### Evaluation of Applicability to Concrete

### Test Example 2

### Production of Concrete Specimens

Cylindrical specimens (Φ 100 mm×200 mm) were produced by using concrete having a standard design compressive strength of 24 MPa shown in Table 2. The concrete specimens were produced by using ready mixed concrete (Remicon) under the same blending conditions. The blending conditions were as follows: Maximum dimension of coarse aggregates: 15 mm, target slump: 10 cm, and target air volume: 4.5±1.5%.

TABLE 2

| Standard design | | | Unit content (kg/m³) | | | |
|---|---|---|---|---|---|---|
| compressive strength | W/C (%) | S/a (%) | W | C | S | G |
| Fc = 24 MPa | 48 | 46 | 178 | 370 | 771 | 891 |

### Test Example 3

### Penetration Depth

Each of the concrete specimens produced in Test Example 2 was dipped in each of the concrete reinforcing material compositions prepared in Examples 1 to 4 for 4 hours and was split into two equal parts by a splitting tensile strength by using a universal tensil machine (UTM). The penetration depth of the concrete reinforcing material compositions in the concrete specimens was measured. The results are shown in Table 3.

TABLE 3

Weight ratio of silicate to
acrylate monomer mixture

| Sample | 50:50 | 65:35 | 80:20 | 95:5 |
|---|---|---|---|---|
| Viscosity (cps) | 2.5 | 18 | 23 | 25 |

As is evident from the results of Table 3, the penetration depth of the concrete reinforcing material compositions was increased as the weight of the silicate was increased.

### Test Example 4

### Concrete Reinforcing Effects

After each of the concrete reinforcing materials prepared in Examples 1 to 4 was applied onto each of the concrete specimens produced in Test Example 2, and increase in the strength of the specimens was analyzed by the compressive strength test method of KS F 2405. Specifically, each of the cylindrical specimens (Φ 100 mm×200 mm) was dipped in each of the concrete reinforcing materials prepared in Examples 1 to 4 for 4 hours. The resulting specimens were air-dried and cured indoors at a temperature of 23° C. and a relative humidity of 55% for three days, and then the air-dried and cured specimens were subject to compressive strength test in accordance with the procedure of KS F 2405. The compressive strength test was conducted by applying a constant load of 1.5-3.5 kg/cm² per second to the cured concrete specimens by using a universal testing machine until the concrete specimens were destroyed. Each compressive strength value is an average of the obtained values obtained from three specimens. An increase in the strength of the concrete specimens, to which the concrete reinforcing materials produced in Examples 1 to 4 were applied, was compared with that of non-applied concrete. The results are shown in Table 4.

TABLE 4

| | | Non- | Weight ratio of silicate to | | | |
|---|---|---|---|---|---|---|
| | | applied | acrylate monomer mixture | | | |
| Sample | | concrete | 50:50 | 65:35 | 80:20 | 95:5 |
| Fc = 24 MPa | Compres- | 25.7 | 28.5 | 32.3 | 29.6 | 28.3 |
| | sive | | | | | |
| | strength | | | | | |
| | (MPa) | | | | | |
| | Increase in | — | 10.8% | 25.7% | 15.2% | 10.1% |
| | strength | | | | | |

As is apparent from the results of Table 4, the concrete specimens, to which the concrete reinforcing materials of the present invention were applied, showed a 10.1-25.7% increase in concrete reinforcing effects (strength enhancing effects), compared to the non-applied concrete. In addition, the concrete specimen, which comprises the silicate and the monomer in a weight ratio of 65:35, showed the highest concrete reinforcing effects.

### Test Example 5

### Test for Water Permeability Coefficient Ratio

Rectangular parallelepiped concrete specimens (200×200×100 mm) were produced by using the concrete shown in Table 2. 40 cc of each of the compositions prepared in Examples 1 to 4 was applied onto each of the concrete specimens, and then air-dry curing was performed for 3 days. The water permeability of the cured concrete specimens was measured by using a GWT-4000 kit (German Instruments INC, Germany), which is an apparatus for non-destructively measuring the water permeability of concrete. As shown in FIG. 1, first, distilled water was injected into a water-filling cup until the level was above a valve. The surface of concrete was wetted at ambient atmosphere for 10 minutes and then the distilled water was penetrated into the concrete surface at 1 atm for 5 minutes, and finally the water permeability of the concrete was evaluated. The water permeability coefficient ratio was calculated by comparing the water permeability coefficient of the concrete, to which each of the compositions was applied, with that of non-applied concrete. The water permeability coefficient was calculated by the following equation.

$${C}_{cp} = \frac{q}{P / L} [ {mm}^{2} / sec \cdot BAR ]$$

wherein

C_{cp}: Water permeability coefficient

q: Flow rate (mm/sec)

P: Atmospheric pressure (P=1 BAR)

L: Thickness of gasket (15 mm)

The water permeability coefficients of the compositions prepared in Examples 1 to 4 are shown in Table 5.

TABLE 5

| | | Weight ratio of silicate to | | | |
|---|---|---|---|---|---|
| | Non-applied | acrylate monomer mixture | | | |
| Sample | concrete | 50:50 | 65:35 | 80:20 | 95:5 |
| Water permeability | 0.0092 | 0.0008 | 0.0008 | 0.0009 | 0.0024 |
| coefficient | | | | | |
| (mm²/sec.BAR) | | | | | |
| Water permeation | — | 91% | 91% | 90% | 74% |
| blocking | | | | | |
| performance | | | | | |

From the results of Table 5, it was confirmed that the concrete specimens, to which the compositions prepared in Examples 1 to 3 were applied, showed a 90% or more increase in water permeation blocking performance except a weight ratio of 95:5 of silica to acrylate monomer mixture, compared to the non-applied concrete, which indicates that the concrete specimens possessed superior waterproof effects.

### Test Example 6

### Chloride Blocking Performance

The chloride blocking performance was evaluated in accordance with the following procedure. First, concrete specimens (200×200×100 mm) were produced by using the blending ratio of the concrete shown in Table 2. After 40 cc of each of the compositions prepared in Examples 1 to 4 was applied onto the top surface of the concrete specimens, the surfaces other than the top surface of the concrete specimens were coated with an epoxy resin to induce the one-directional penetration of a chloride. The coated concrete specimens were dipped in NaCl (3.6%) solution. After 90 days of the dipping, the concrete specimens were tested for the content of the soluble chloride at different depths. The chloride content of the concrete specimens was determined by collecting samples (each 20 g) from a depth of 5 mm below the concrete surface, extracting the chloride from the samples in accordance with the “method of measuring salt content in cured concrete” specified by the Japan Concrete Institute, and measuring the amount of the chloride by using AG-100 (Kett Electric Laboratory, Japan) by an ion electrode method. The results are shown in Table 6.

TABLE 6

| | Non- | Weight ratio of silicate to | | | |
|---|---|---|---|---|---|
| | applied | acrylate monomer mixture | | | |
| Sample | concrete | 50:50 | 65:35 | 80:20 | 95:5 |
| Chloride concentration (%) | 0.053 | 0.004 | 0.005 | 0.004 | 0.015 |
| Chloride blocking performance | — | 92% | 90% | 92% | 71% |

As can be seen from the results of Table 6, the concrete specimens, to which the concrete reinforcing materials prepared in Examples 1 to 3 were applied, had a chloride blocking ratio of 0.9 or more, except a weight ratio of 95:5 of silicate to acrylate monomer mixture, which indicates that the concrete specimens showed a ˜90% increase in chloride blocking effects when compared to the non-applied concrete.

### Comparison with Conventional Concrete Reinforcing Agent Compositions

### EXAMPLE 5

60% by weight of tetraethylorthosilicate, 28.3% by weight of butyl acrylate, 9.7% by weight of methyl methacrylate, and 2% by weight of hydroxyethyl acrylate were introduced into a polymerization reactor, and then AIBN as a reaction initiator was added thereto. The procedure of Example 1 was repeated to prepare a concrete reinforcing material.

### Test Example 7

### Performance Comparison with Conventional Concrete Reinforcing Agent Compositions

The performance of the concrete reinforcing material prepared in Example 5 was compared with that of commercially available products (S company, U.S.A.; R company, Australia). The procedures of Test Examples 1 to 6 were repeated, and the results are shown in Table 7.

TABLE 7

| | | Non- | | S | R |
|---|---|---|---|---|---|
| | | applied | | company, | company, |
| Sample | | Concrete | Example 5 | U.S.A. | Australia |
| Concrete reinforcing effects | Compressive strength | 25.7 | 31.3 | 29.7 | 26.4 |
| | (MPa) | | | | |
| | Increase in strength | — | 21.8% | 15.6% | 2.7% |
| Water permeability | Water permeability coefficient | 0.0092 | 0.0009 | 0.0084 | 0.0011 |
| | (mm²/sec.bar) | | | | |
| | Water permeation blocking | — | 90.2% | 8.7% | 88.0% |
| | performance | | | | |
| Chloride blocking | Chloride concentration (%) | 0.053 | 0.004 | 0.042 | 0.005 |
| performance | Chloride blocking performance | — | 92.4% | 79.2% | 90.6% |

| | | | | |
|---|---|---|---|---|
| Penetration depth (mm) | — | 17 | 18 | 2 |

As is evident from the results of Table 7, the compositions of the present invention showed excellent results in terms of concrete reinforcing effects, water permeability, chloride blocking performance and penetration depth. The product (S company, U.S.A.) showed excellent results in terms of concrete reinforcing effects and penetration depth, but showed poor results in terms of water permeation blocking performance and chloride blocking performance. It is believed that since the product (S company, U.S.A.) uses a silicate compound based on amorphous silica (SiO₂), it showed concrete reinforcing effect but showed poor water permeation blocking performance and chloride blocking performance due to hydrophilicity of the amorphous silica. Since the product (R company, Australia) is modified sodium silicate (Na₂O—nSiO₂), it is believed that the product showed insignificant penetration depth and concrete reinforcing performance due to its reactivity with cement. On the contrarys, it is believed since a sol-gel reaction of the alkoxysilicate used in the composition of Example 5 needs about 8 to about 24 hours, the composition showed good penetration capability into concrete and excellent concrete reinforcing effects due to the sol-gel reaction proceeded after penetration. In addition, excellent water permeation blocking performance and good chloride blocking performance of the composition prepared in Example 5 are believed to be because the silicate and the monomers were polymerized within capillary pores of concrete.

As apparent from the above test results, the concrete reinforcing material of the present invention has a low volatility at room temperature due to its high boiling point. In addition, high penetration capability of the concrete reinforcing material according to the present invention into concrete leads to an increase in the strength of concrete and an enhancement in water permeation blocking performance and chloride blocking performance, which are greatly helpful in improving the concrete reinforcing performance and durability performance of concrete structures. When the concrete reinforcing material of the present invention is applied onto a concrete structure, it is rapidly diffused into the concrete due to capillary suction of concrete structure. Therefore, the concrete reinforcing material of the present invention is highly effective in preventing aging and improving the durability performance of general concrete structures, power plant structures (e.g., hangar and auxiliary buildings of atomic power plants) and concrete structures in marine environment (e.g., seawater intake structures). Moreover, the concrete reinforcing material of the present invention shows excellent anti-aging effect even in power transmission and distribution systems, such as power cables.

1. A process for preparing a concrete reinforcing material, the process comprising the steps of:
adding 50 to 95% by weight of an alkoxysilicate and 5 to 50% by weight of a mixture of hydroxyalkylacrylate monomer and alkylacrylate monomer to a reactor;
adding a catalyst to the reactor;
stirring the mixture at a constant speed of 30-100 rpm while introducing nitrogen gas into the reactor; and
reacting the mixture for 5 -10 hours while maintaining the internal temperature of the reactor at 60-100° C.

2. The process according to claim 1, further comprising the steps of stopping the introduction of nitrogen gas when ethanol is not discharged through a reflux condenser from the reactor any further or is discharged in an amount of less than 20% of the amount discharged at the initial stage of the reaction, and lowering the temperature of the reaction product to 40° C. or less.

3. The process according to claim 1, wherein the said alkoxysilicate is added in an amount of 70 to 90% by weight, and the said alkylacrylate monomer is added in an amount of 10 to 30% by weight.

4. The process according to claim 1, wherein the stirring is carried out at a speed of 40 to 80 rpm, and the reaction is performed at 80-90° C. for 7-9 hours.

5. The process according to claim 1, wherein the said alkoxysilicate has one to ten carbon atoms, and the said substituted or unsubstituted alkylacrylate monomer has one to ten carbon atoms.

6. The process according to claim 1, wherein the said alkoxysilicate is selected from the group consisting of tetraethylorthosilicate, tetramethylorthosilicate, trimethylmethoxyorthosilicate, trimethylethoxyorthosilicate, dimethyldimethoxyorthosilicate, dimethyldiethoxyorthosilicate, methyltrimethoxyorthosilicate, methyltriethoxyorthosilicate, tetramethoxyorthosilicate, tetraethoxyorthosilicate, methyldimethoxyorthosilicate, methyldiethoxyorthosilicate, dimethylethoxyorthosilicate, dimethylvinylmethoxyorthosilicate, dimethylvinylethoxyorthosilicate, methylvinyldimethoxyorthosilicate, dimethylvinylmethoxyorthosilicate, dimethylvinylethoxyorthosilicate, methylvinyldimethoxyorthosilicate, methylvinyldiethoxyorthosilicate, diphenyldimethoxyorthosilicate, diphenyldiethoxyorthosilicate, phenyltrimethoxyorthosilicate, phenyltriethoxyorthosilicate, octadecyltrimethoxyorthosilicate, octadecyltriethoxyorthosilicate, and mixtures thereof.

7. The process according to claim 1, wherein the said alkylacrylate monomer is selected from the group consisting of butyl acrylate, methyl methacrylate, and a mixture thereof.

8. The process according to claim 1, wherein the said hydroxyalkylacrylate monomer is hydroxyethyl acrylate.

9. The process according to claim 1, wherein the catalyst is a reaction initiator selected from 2,2′-azo-bis-isobutyronitrile (AIBN, C₈H₁₂N₄) and amidobenzonitrile (AMBN, C₁₀H₁₆N₄).

10. The process according to claim 1, wherein the monomer mixture consists of 4 to 10% by weight of at least one hydroxyalkylacrylate monomer having a hydroxyl group and 90 to 96% by weight of at least one alkylacrylate monomer having no hydroxyl group.

11. A concrete reinforcing material prepared by the process according to claim 1.

12. A concrete reinforcing material prepared by the process according to claim 2.

13. A concrete reinforcing material prepared by the process according to claim 3.

14. A concrete reinforcing material prepared by the process according to claim 4.

15. A concrete reinforcing material prepared by the process according to claim 5.

16. A concrete reinforcing material prepared by the process according to claim 6.

17. A concrete reinforcing material prepared by the process according to claim 7.

18. A concrete reinforcing material prepared by the process according to claim 8.

19. A concrete reinforcing material prepared by the process according to claim 9.

20. A concrete reinforcing material prepared by the process according to claim 10.
